(19) United States
(12) Patent Application Publication
(10) Pub. No.: US 2023/0339002 A1
(43) Pub. Date: Oct. 26, 2023

(54) GRINDING-TYPE SOLAR MODULE RECYCLING EQUIPMENT

(71) Applicant: Ting-Fu CHUANG, Tainan City (TW)

(72) Inventor: Ting-Fu CHUANG, Tainan City (TW)

(21) Appl. No.: 18/303,385

(22) Filed: Apr. 19, 2023

(30) Foreign Application Priority Data
Apr. 21, 2022 (TW) 111115315

(51) Int. Cl. B09B 3/35; B24B 55/06

(52) U.S. Cl. CPC B09B 3/35; B24B 55/06; B09B 2101/15

(57) ABSTRACT

A grinding-type solar module recycling equipment having a platform, a grinding blade and a negative pressure collector. A solar module is placed on a solar module placement area of the platform and the grinding blade is controlled to touch and grind the solar module layer by layer. The powders ground from different layers of the solar module is separately and immediately recycled by the negative pressure suction head. Therefore, the powders do not fall around. The grinding-type solar module recycling equipment not only does not generate secondary pollutants, but also has high purity of powdered recycled materials, which is convenient for subsequent utilization.

### CROSS-REFERENCE TO RELATED APPLICATIONS

This application is based upon and claims priority under 35 U.S.C. 119 from Taiwan Patent Application No. 111115315 filed on Apr. 21, 2022, which is hereby specifically incorporated herein by this reference thereto.

### BACKGROUND OF THE INVENTION

### 1. Field of the Invention

The present disclosure relates to a solar module recycling equipment, more particularly to a grinding-type solar recycling equipment.

### 2. Description of the Prior Arts

Solar module recycling equipment generally includes chemical-type recycling equipment and physical-type recycling equipment. Currently, chemical-type recycling equipment is mainstream. However, waste liquid generated after chemical-type recycling equipment causes secondary environmental pollution, there is still no environmental benefit, and the recycling rate of available material is low. Thus, the material recycled from the chemical-type recycling equipment is not convenient for subsequent utilization.

Physical-type recycling equipment has been patented by several manufacturers. As shown in FIGS. 7(a) and 7(b) of Japanese Patent Publication No. JP2011173099A, in the equipment for recycling solar modules, an outer layer of a solar module is first crushed. Then, the crushed outer layer is scraped from a surface contacting with a lower layer by a single blade, which has the same width as the solar module to recycle irregular fragments.

As shown in FIGS. 3 and 4 of granted Korean Utility Model No. KR102091346B1, a double-blade cutting head having a first blade and a second blade is used. In the apparatus for recycling solar panels, an outer layer of a solar module is first split to form a groove by the first blade to define a strip area. Then, the strip area is scraped from a surface contacting with a lower layer by the second blade having the same width as the strip area to recycle strips.

As shown in FIG. 2A of Taiwanese Patent Publication No. TW202132171A, in the Solar panel recycling apparatus, the solar module is first heated by a heating table. Then a solar cell layer is cut to form a cutting part with a pre-cutting device. Finally, the solar cell layer is scraped by a blade part of a scraper module.

The aforementioned patents use the blade to perform the physical recycling of the solar module and do not generate secondary pollution waste liquid compared to chemical recycling. However, because the solar module is a stacked structure and is recycled in a manner of scraping, the materials of different layers are easy to be mixed in a recycled content. Therefore, the recycling accuracy is not good enough and the recycled content has to be refined before use. Thus, the overall recycling efficiency is poor and needs further improvement.

### SUMMARY OF THE INVENTION

An objective of the present invention is to provide a grinding-type solar module recycling equipment.

To achieve the objection as mentioned above, the grinding-type solar module recycling equipment includes:
a platform having a solar module placement area;
a grinding blade disposed on the platform and moving relatively to the solar module placement area; and
a negative pressure collector having a negative pressure suction head and disposed on the platform to negatively collect grinding powders, wherein the grinding blade and the negative pressure suction head are mounted in a housing.

With the foregoing description, the grinding-type solar module recycling equipment in accordance with the present invention mainly grinds the solar module layer by layer by using the grinding blade. The powders ground from different layers of the solar module are separately and quickly recycled through the negative pressure suction head of the negative pressure collector. Furthermore, the grinding blade and the negative pressure suction head are mounted in a housing. Therefore, when the grinding blade moves relative to the platform, the negative pressure suction head synchronously moves with the grinding blade. The powders ground by the grinding blade are immediately sucked by the negative pressure suction head, and the powders do not fall around. Additionally, the present invention not only does not generate secondary pollutants but also has high purity of powdered recycled materials, which is convenient for subsequent utilization.

### BRIEF DESCRIPTION OF THE DRAWINGS

FIG. 1 is a schematic view of a grinding-type solar module recycling equipment in accordance with the present invention;

FIG. 2A is a perspective view of an embodiment of the grinding-type solar module recycling equipment in accordance with the present invention;

FIG. 2B is a schematic view of a grinding blade in accordance with the present invention;

FIG. 3 is a perspective view of another embodiment of the grinding-type solar module recycling equipment in accordance with the present invention;

FIG. 4A is a side plane view of a grinding blade and negative pressure suction head in accordance with the present invention;

FIGS. 4B and 4C are different side plane views of another grinding blade and negative pressure suction head in accordance with the present invention;

FIG. 5 is a functional block diagram of the grinding-type solar module recycling equipment in accordance with the present invention;

FIG. 6 is a schematic view illustrating the operation of the grinding-type solar module recycling equipment in accordance with the present invention;

FIGS. 7A to 7E are schematic views illustrating the operation of the grinding-type solar module recycling equipment in accordance with the present invention;

FIG. 8A is a top plane view of another embodiment of the grinding-type solar module recycling equipment in accordance with the present invention; and

FIG. 8B is a schematic side plane view of a solar module in FIG. 8A.

### DETAILED DESCRIPTION OF THE EMBODIMENTS

With multiple embodiments and drawings thereof, the features of the present invention are described in detail as follows.

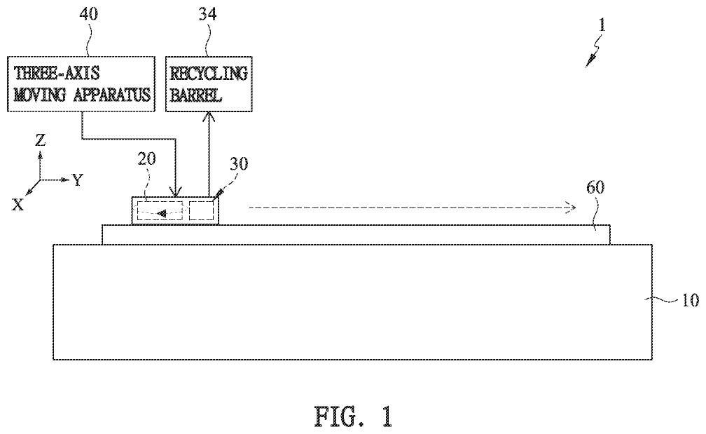

With reference to FIG. 1, the grinding-type solar module recycling equipment 1 includes a platform 10, a grinding blade 20, and a negative pressure collector 30. In the present embodiment, a solar module 60 is placed on the platform 10. The grinding blade 20 and the negative pressure collector 30 are disposed on the platform 10 to move relative to the solar module 60 placed on the platform 10. In one embodiment, the grinding-type solar module recycling equipment 1 further has a three-axis moving apparatus 40 fixed to the platform 10. The grinding blade 20 and the negative pressure collector 30 are controlled by the three-axis moving apparatus 40 to move along three axes. The grinding blade 20 grinds the solar module 60 layer by layer, and the powders generated by grinding different layers of the solar module 60 are separately recycled through the negative pressure collector 30.

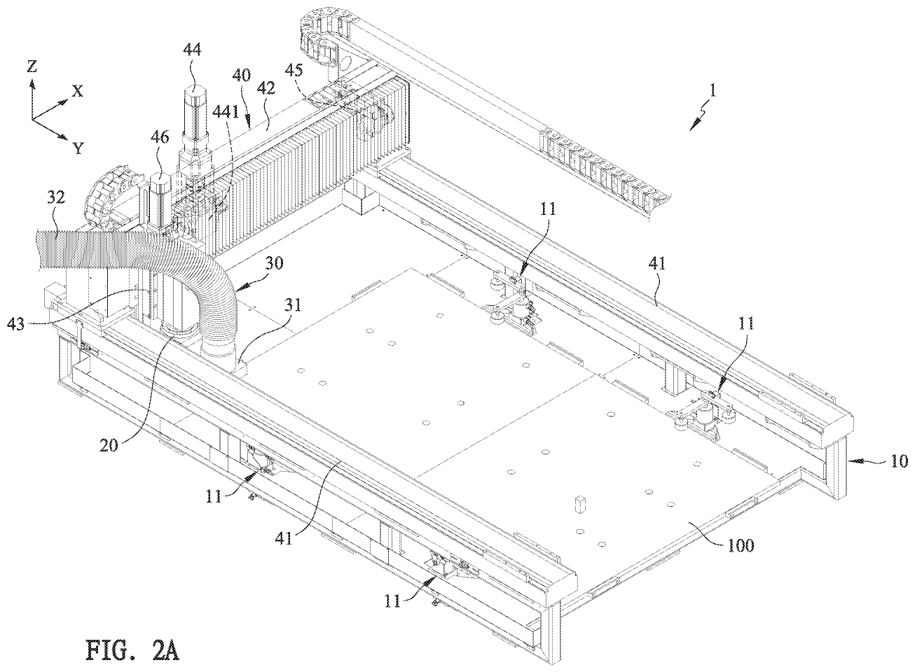

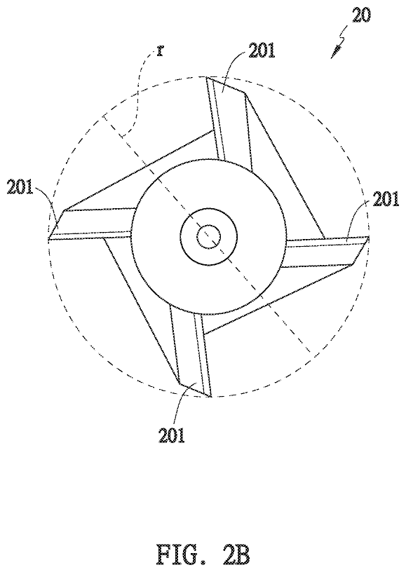

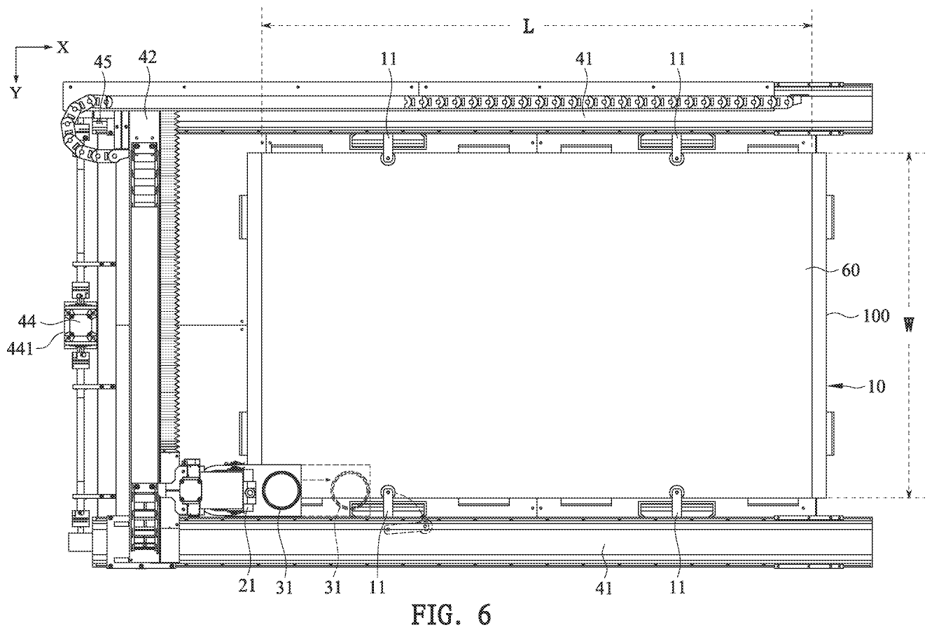

With reference to FIGS. 2A and 6, the platform 10 has a solar module placement area 100, and the solar module 60 is placed on the solar module placement area 100. In the present embodiment, the platform 10 further includes a plurality of positioners 11. The positioners 11 are mounted on two opposite sides of the solar module placement area 100 to fasten the solar module 60 on the solar module placement area 100. In one embodiment, each positioner 11 may be an electrical control clamping device having a rotary cylinder and a clamper. After the rotary cylinder is electrically controlled, the rotary cylinder controls the clamper to pivot relative to the corresponding side of the solar module placement area 100. Thus, the clamper may be pivoted in or pivoted out of the solar module placement area 100 to fasten the solar module 60 to the solar module placement area 100.

With reference to FIGS. 2A and 6, the grinding blade 20 and the three-axis moving apparatus 40 are disposed on the platform 10. As shown in FIG. 2B, the grinding blade 20 may consist of a plurality of blades 201. In one embodiment, the blades 201 are arranged in a circle and the grinding blade 20 has a grinding diameter “r”. With reference to FIGS. 2B and 6, the grinding diameter “r” is less than a width “W” and a length “L” of the solar module 60. In the present embodiment, as shown in FIG. 2A, the three-axis moving apparatus 40 includes two Y-axis sliding table sets 41, an X-axis sliding table set 42, a Z-axis sliding table set 43, a Y-axis motor 44, an X-axis motor 45, and a Z-axis motor 46. The Y-axis sliding table sets 41 are respectively mounted on two opposite sides of the platform 10 parallel with a Y-axis. The Y-axis motor 44 is fixed to another side of the platform 10 parallel with an X-axis. In one embodiment, the Y-axis motor 44 may be connected to the two Y-axis sliding table sets 41 through a direction-changing device 441 to synchronously move of the Y-axis sliding table sets 41. The X-axis sliding table set 42 is mounted on the two Y-axis sliding table sets 41 to move along the Y-axis. The X-axis motor 45 is fixed to the X-axis sliding table set 42 to move the X-axis sliding table 42. The Z-axis sliding table set 43 is mounted on the X-axis sliding table set 42 and moves along the X-axis. The grinding blade 20 is fixed to the Z-axis sliding table set 43. The Z-axis motor 46 is fixed to the Z-axis sliding table set 43 to move the Z-axis sliding table set 43. Therefore, the grinding blade 20 can move along a Z-axis. Accordingly, an X-Y plane position (plane position) of the grinding blade 20 relative to the platform 10 may be adjusted by the X-axis motor 45 and the Y-axis motor 44. A Z-axis position (height position) of the grinding blade 20 relative to the platform 10 may be adjusted by the Z-axis motor 46. The three-axis moving apparatus 40 is not limited to the manner disclosed herein, as long as an apparatus that moves the grinding blade 20 relative to the platform 10 in X, Y, and Z axes may be used as the three-axis moving apparatus 40 of the present invention.

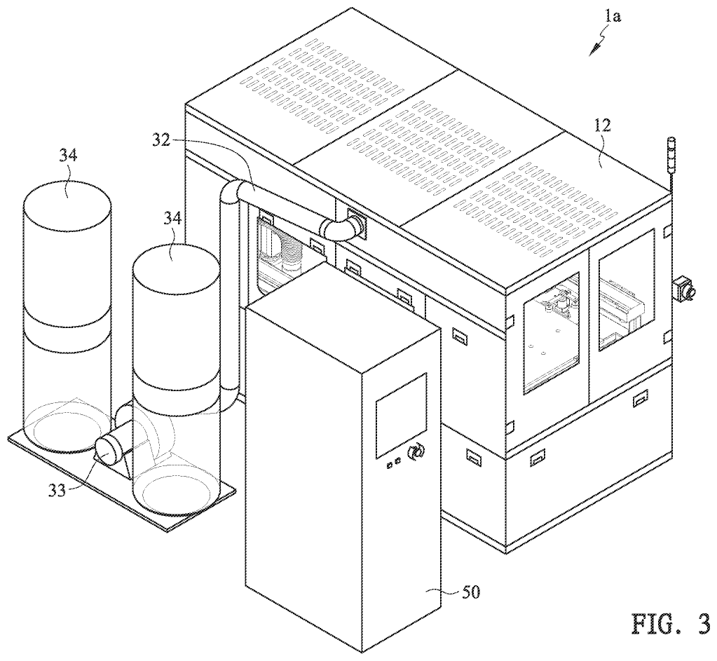

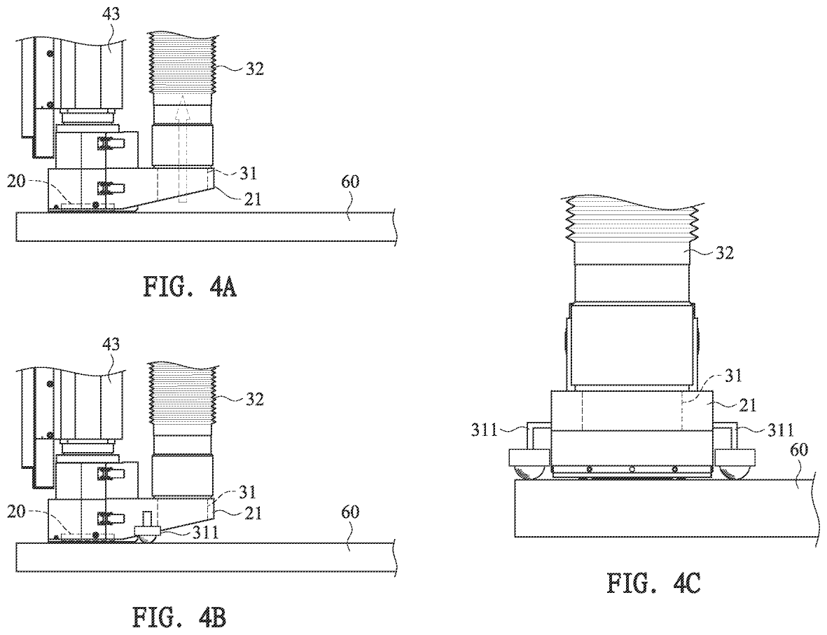

With reference to FIGS. 2A and 3, the negative pressure collector 30 is disposed on the platform 10 to suck powders generated by the solar module 60 ground by the grinding blade 20. In the present embodiment, the negative pressure collector 30 includes a negative pressure suction head 31, a pipe assembly 32, and a pump 33. The negative pressure suction head 31 communicates with the pump 33 through the pipe assembly 32. The pump 33 further communicates with at least one recycling barrel 34. In one embodiment, the negative pressure suction head 31 is mounted on a side of the grinding blade 20. As shown in FIG. 4A, the grinding blade 20 and the negative pressure suction head 31 are mounted in a housing 21. Therefore, when the grinding blade 20 moves relatively to the platform 10 through the three-axis moving apparatus 40, the negative pressure suction head 31 synchronously moves with the grinding blade 20. The powders ground by the grinding blade 20 are immediately sucked by the negative pressure suction head 31 to avoid the powders falling around. As shown in FIGS. 4B and 4C, two pressing wheels 311 may be further respectively disposed on two opposite sides of the housing 21 corresponding to the negative pressure suction head 31. Therefore, the pressing wheels 311 avoid negative pressure wrinkling the thinned solar module 60. In one embodiment, each pressing wheel 311 may be a universal wheel, such as a ball wheel. In another embodiment, the negative pressure collector 30 may include a plurality of recycling barrels 34 corresponding to different material layers of the solar module 60. In another embodiment, as shown in FIG. 3, the grinding-type solar module recycling equipment la further includes an operation chamber 12 compared to the grinding-type solar module recycling equipment 1 as shown in FIG. 2A. The pipe assembly 32, the pump 33, and the at least one recycling barrel 34 of the negative pressure collector 30 may be disposed outside the operation chamber 12.

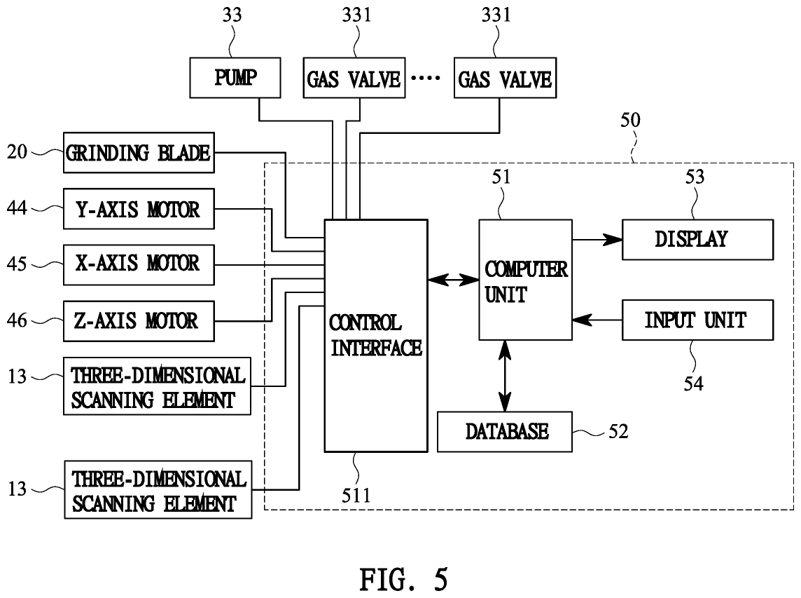

With reference to FIG. 5, the grinding-type solar module recycling equipment 1 of the present invention further includes an electrical control system 50. The electrical control system 50 at least includes a computer unit 51, a control interface 511, and a database 52. The computer unit 51 is electrically connected to the positioners 11 of the platform 10, the grinding blade 20, the Y-axis motor 44, the X-axis motor 45, and the Z-axis motor 46 of the three-axis moving apparatus 40, and the pump 33 through the control interface 511. The database 52 stores data on the solar module 60 including size, information on the material layers (such as number of layers, thickness of layers, material properties, and so on), manufacturer, product barcode, and so on. The database 52 further sets and stores grinding paths corresponding to different solar modules 60. The grinding path is determined at least by the size, the number of layers, and the thickness of layers of the solar module 60 to achieve fully automatic and completely precise grinding. Furthermore, the computer unit 51 is further electrically connected to a display 53 and an input unit 54 to display an operation interface and establish the data stored in the database 52. Moreover, the input unit 54 may further include a barcode scanner to scan the product barcode of the solar module 60. Therefore, the computer unit 51 may quickly read the data of the same solar module 60 to perform grinding and recycling operations.

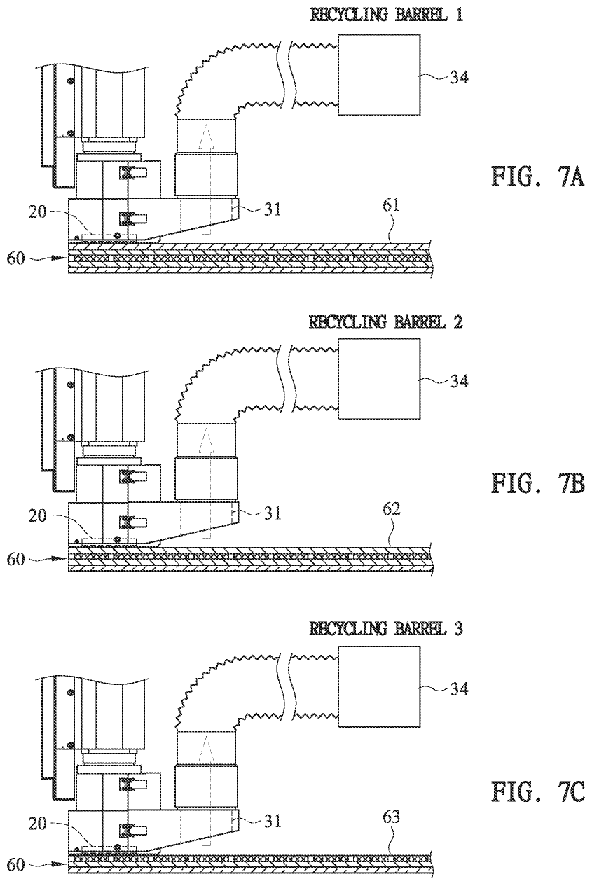

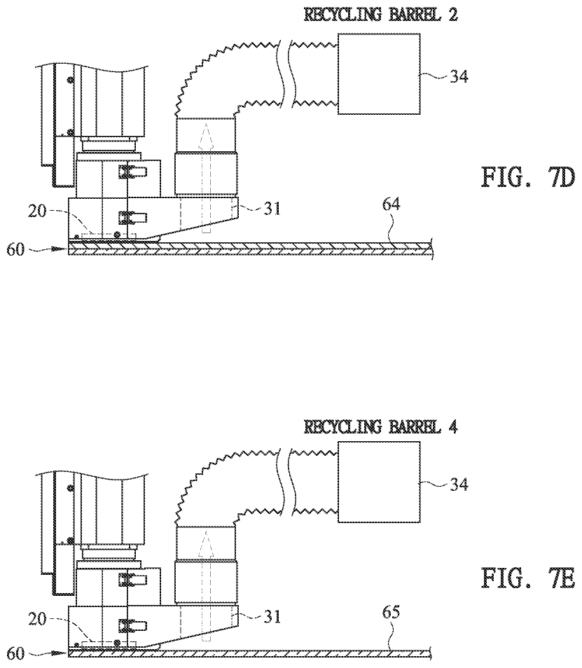

With reference to FIGS. 6 and 7, when a solar module 60 is placed on the solar module placement area 100 of the platform 10, the positioners 11 of the platform 10 are controlled by the computer unit 51 of the electrical control system 50 and pivot in the solar module placement area 100 to clamp and fasten the solar module 60 to the platform 10. The data of the solar module 60 may be read from the database 52 of the electrical control system 50 by scanning or entering the product barcode of the solar module 60 to determine the grinding path of the grinding blade 20. As shown in FIG. 6, the grinding blade 20 moves according to the grinding path, and the grinding path marks the positions of the positioners 11. When the grinding blade 20 approaches any one of the positioners 11, the positioner 11 is controlled to pivot out the solar module placement area 100 to allow the grinding blade 20 to pass through. After the grinding blade 20 passes, the positioner 11 pivots in the solar module placement area 100. Therefore, the current material layer of the solar module 60 is completely ground. Furthermore, because the material properties of the material layers are different, the computer unit 51 may set grinding depth and number of grinds of the grinding blade 20 according to the type of the grinding blade 20. Because the grinding depth is precisely controlled, precise grinding is completely achieved.

Assuming that the solar module 60 currently placed has five material layers and the material of two of the material layers are the same, four recycling barrels 34 may be prepared. As shown in FIG. 3, the pipe assembly 32 selectively communicates with the four recycling barrels 34 through four gas valves 331. The gas valves 331 are controlled by the computer unit 51 to be opened or closed through the control interface 511, so each pipe assembly 32 selectively communicates with one of the recycling barrels 34. As shown in FIG. 7A, the grinding blade 20 first grinds a first material layer 61 of the solar module 60, and powders generated from grinding the first material layer 61 are immediately sucked by the negative pressure suction head 31 and then stored in the recycling barrel 1. After the first material layer 61 is completely ground, as shown in FIG. 7B, the computer unit 51 controls the grinding blade 20 to rotate and grind a second material layer 62. Then, powders generated from grinding the second material layer 62 are immediately sucked by the negative pressure suction head 31 and then stored in the recycling barrel 2. After the second material layer 62 is completely ground, as shown in FIG. 7C, the computer unit 51 controls the grinding blade 20 to grind a third material layer 63. Then, powders generated from grinding the third material layer 63 are immediately sucked by the negative pressure suction head 31 and then stored in the recycling barrel 3. After the third material layer 63 is completely ground, as shown in FIG. 7D, the computer unit 51 controls the grinding blade 20 to grind a fourth material layer 64. Because the material of the fourth material layer 64 and the second material layer 62 are the same, powders generated from grinding the fourth material layer 64 are immediately sucked by the negative pressure suction head 31 and then stored in the recycling barrel 2. After the fourth material layer 64 is completely ground, as shown in FIG. 7E, the computer unit 51 controls the grinding blade 20 to grind a fifth material layer 65. Then, powders generated from grinding the fifth material layer 65 are immediately sucked by the negative pressure suction head 31 and then stored in the recycling barrel D. Consequently, the solar module 60 is completely ground and recycled and no waste material or waste liquid is generated.

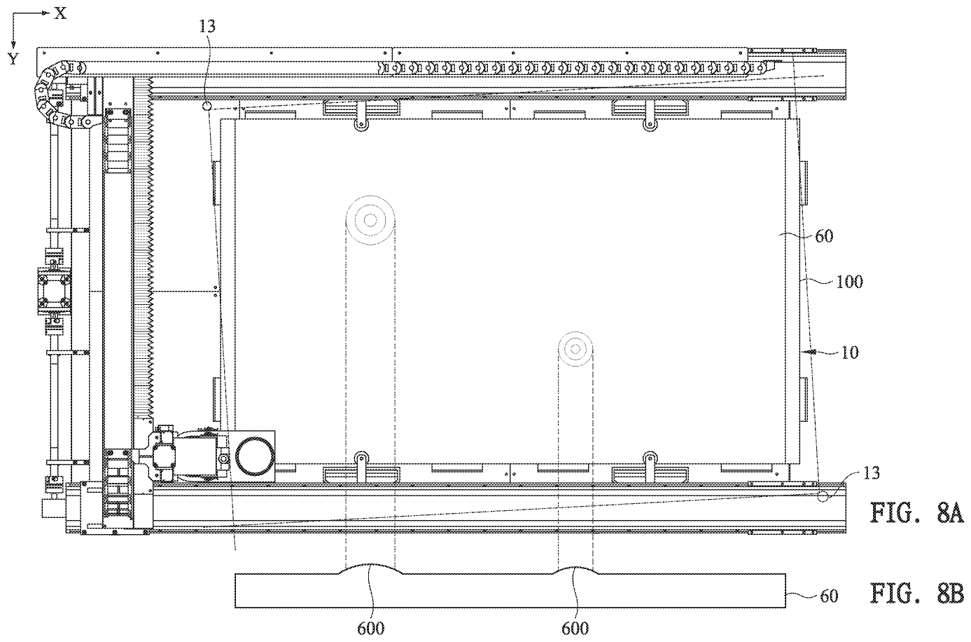

As shown in FIG. 5, the computer unit 51 is further electrically connected to at least one three-dimensional scanning element 13, such as an optical scanner, a sound wave scanner, etc. The three-dimensional scanning element 13 is disposed on the platform 10 to scan a surface profile of the solar module 60. In one embodiment, as shown in FIG. 8A, two three-dimensional scanning elements are respectively disposed on two diagonal positions of the solar module placement area 100 to completely scan the surface profile of the solar module 60. Therefore, the computer unit 51 may obtain the surface profile of the solar module 60 and determine and calculate the position of bulges 600 and thickness change as shown in FIG. 8B. The computer unit 51 controls the grinding blade 20 to grind the solar module 60 according to the grinding path. When the grinding blade 20 reaches the position of the bulge 600, the grinding blade 20 lifts or lowers according to the calculated thickness change of the bulge 600. Therefore, when grinding a specific material layer having the bulge 600, complete recycling of powders of the material layer is ensured. The grinding blade 20 does not grind to the next material layer due to the fixed grinding height, causing the recycled powder to be mixed and impure.

With the foregoing description, the grinding-type solar module recycling equipment in accordance with the present invention mainly grinds the solar module layer by layer by using the grinding blade, separately recycles the powders ground from different layers of the solar module through the negative pressure collector, and mounts the grinding blade and the negative pressure suction head in a housing. Therefore, when the grinding blade moves relative to the platform, the negative pressure suction head synchronously moves, so that the powders ground by the grinding blade are immediately sucked by the negative pressure suction head to avoid the powders falling around. Additionally, the present invention not only does not generate secondary pollutants but also has high purity of powdered recycled materials, which is convenient for subsequent utilization.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A solar module recycling equipment comprising:
a platform having a solar module placement area;
a grinding blade disposed on the platform and moving relatively to the solar module placement area; and
a negative pressure collector having a negative pressure suction head and disposed on the platform to collect grinding powders by negative pressure, wherein the grinding blade and the negative pressure suction head are mounted in a housing.

2. The solar module recycling equipment as claimed in claim 1, wherein the negative pressure collector comprises:
a pump generating the negative pressure and communicating with at least one recycling barrel; and
a pipe assembly connected between the negative pressure suction head and the pump, wherein the negative pressure suction head communicates with the pump through the pipe assembly.

3. The solar module recycling equipment as claimed in claim 2, wherein a plurality of positioners are mounted on two opposite sides of the platform.

4. The solar module recycling equipment as claimed in claim 3, wherein two pressing wheels are respectively disposed on two opposite sides of the housing corresponding to the negative pressure suction head.

5. The solar module recycling equipment as claimed in claim 3, wherein the pump communicates with a plurality of recycling barrels through a plurality of gas valves.

6. The solar module recycling equipment as claimed in claim 5 further comprising an operation chamber, wherein the platform, the grinding blade, the negative pressure suction head of the negative pressure collector, and a part of the pipe assembly are disposed inside the operation chamber, and the pump and the recycling barrels are disposed outside the operation chamber.

7. The solar module recycling equipment as claimed in claim 5, wherein
a three-axis moving apparatus is disposed on the platform; and
the grinding blade and the negative pressure suction head are fixed to and controlled by the three-axis moving apparatus to move along three axes in the solar module placement area.

8. The solar module recycling equipment as claimed in claim 6, wherein
a three-axis moving apparatus is disposed on the platform; and
the grinding blade and the negative pressure suction head are fixed to and controlled by the three-axis moving apparatus to move along three axes in the solar module placement area.

9. The solar module recycling equipment as claimed in claim 7, wherein the three-axis moving apparatus comprises:
two Y-axis sliding table sets respectively mounted on two opposite sides of the platform parallel with a Y-axis;
a Y-axis motor fixed to a side of the platform parallel with an X-axis and connected to the two Y-axis sliding table sets through a direction-changing device to synchronously move the two Y-axis sliding table sets;
an X-axis sliding table set mounted on the two Y-axis sliding table set and moving along the Y-axis;
an X-axis motor fixed to the X-axis sliding table set to move the X-axis sliding table set;
a Z-axis sliding table set mounted on the X-axis sliding table set to move along the X-axis; wherein the grinding blade is fixed to the Z-axis sliding table set; and
a Z-axis motor fixed to the Z-axis sliding table set to move the Z-axis sliding table set so the grinding blade moves along a Z-axis.

10. The solar module recycling equipment as claimed in claim 8, wherein the three-axis moving apparatus comprises:
two Y-axis sliding table sets respectively mounted on two opposite sides of the platform parallel with a Y-axis;
a Y-axis motor fixed to a side of the platform parallel with an X-axis and connected to the two Y-axis sliding table sets through a direction-changing device to synchronously move the two Y-axis sliding table sets;
an X-axis sliding table set mounted on the two Y-axis sliding table set and moving along the Y-axis;
an X-axis motor fixed to the X-axis sliding table set to move the X-axis sliding table set;
a Z-axis sliding table set mounted on the X-axis sliding table set to move along the X-axis; wherein the grinding blade is fixed to the Z-axis sliding table set; and
a Z-axis motor fixed to the Z-axis sliding table set to move the Z-axis sliding table set so the grinding blade moves along a Z-axis.

11. The solar module recycling equipment as claimed in claim 9 further comprising an electrical control system having:
a computer unit electrically connected to the grinding blade, the positioner, the Y-axis motor, the X-axis motor, the Z-axis motor, the pump, and the gas valves through a control interface, wherein the computer unit controls each positioner to pivot in or pivot out of the solar module placement area;
a database storing size, number, thickness, and material properties of material layers, manufacturer, product barcode, and grinding path of the solar module, wherein the grinding path is determined at least by the size, number, and thickness of material layers of the solar module;
a display electrically connected to the computer unit; and
an input unit electrically connected to the computer unit.

12. The solar module recycling equipment as claimed in claim 10 further comprising an electrical control system having:
a computer unit electrically connected to the grinding blade, the positioner, the Y-axis motor, the X-axis motor, the Z-axis motor, the pump, and the gas valves through a control interface, wherein the computer unit controls each positioner to pivot in or pivot out of the solar module placement area;
a database storing size, number, thickness, and material properties of material layers, manufacturer, product barcode, and grinding path of the solar module, wherein the grinding path is at least determined by the size, number, and thickness of material layers of the solar module;
a display electrically connected to the computer unit; and
an input unit electrically connected to the computer unit.

13. The solar module recycling equipment as claimed in claim 11 further comprising at least one three-dimensional scanning element electrically connected to the computer unit through the control interface and disposed on the platform to scan a three-dimensional space of the solar module placement area of the platform.

14. The solar module recycling equipment as claimed in claim 12 further comprising at least one three-dimensional scanning element electrically connected to the computer unit through the control interface and disposed on the platform to scan a three-dimensional space of the solar module placement area of the platform.

15. The solar module recycling equipment as claimed in claim 13, wherein
the computer unit obtains a three-dimensional surface profile pattern of the solar module placed on the platform through the three-dimensional scanning element to determine and calculate a position and a thickness change of each bulge of surface; and
when the computer unit controls the grinding blade to grind along the grinding path and reach the position of the bulge, the grinding blade lifts or lowers according to the calculated thickness change of the bulge.

16. The solar module recycling equipment as claimed in claim 14, wherein
the computer unit obtains a three-dimensional surface profile pattern of the solar module placed on the platform through the three-dimensional scanning element to determine and calculate a position and a thickness change of each bulge of surface; and
when the computer unit controls the grinding blade to grind along the grinding path and reach the position of the bulge, the grinding blade lifts or lowers according to the calculated thickness change of the bulge.

17. The solar module recycling equipment as claimed in claim 1, wherein the grinding blade having a plurality of blades arranged in a circle.

18. The solar module recycling equipment as claimed in claim 17, wherein the grinding blade having a grinding diameter less than a width and a length of a solder module placed on the solar module placement area.
